(19) United States
(12) Patent Application Publication
(10) Pub. No.: US 2015/0125740 A1
(43) Pub. Date: May 7, 2015

(54) LITHIUM ION SECONDARY BATTERY

(71) Applicant: NEC Corporation, Tokyo (JP)

(72) Inventors: Daisuke Kawasaki, Tokyo (JP); Shinya Sudo, Tokyo (JP)

(73) Assignee: NEC Corporation, Tokyo (JP)

(21) Appl. No.: 14/405,339

(22) PCT Filed: May 29, 2013
(86) PCT No.: PCT/JP2013/064945

§ 371 Date: Dec. 3, 2014

(30) Foreign Application Priority Data
Jun. 4, 2012 (JP) 2012-127601

(51) Int. Cl. H01M 4/36; H01M 4/133; H01M 4/134; H01M 10/0566; H01M 4/40; H01M 4/587; H01M 10/0525; H01M 4/131; H01M 4/48

(52) U.S. Cl. CPC H01M 4/364; H01M 4/131; H01M 4/133; H01M 4/134; H01M 4/48; H01M 4/405; H01M 4/587; H01M 10/0525; H01M 10/0566; H01M 2004/027
USPC 429/163; 29/623.2

(57) ABSTRACT

The present invention relates to a lithium ion secondary battery having an electrode element in which a positive electrode and a negative electrode are arranged so as to face each other, an electrolyte and an outer package housing the electrode element and the electrolyte, wherein the negative electrode is formed by using a second negative electrode active material in which lithium is doped into a first negative electrode active material containing a metal (a) capable of forming an alloy with lithium, a metal oxide (b) capable of absorbing and desorbing lithium ions, and a carbon material (c) capable of absorbing and desorbing lithium ions; and the electrolyte contains a fluorinated ether compound represented by a predetermined formula.

### TECHNICAL FIELD

An embodiment according to the present invention relates to a lithium ion secondary battery, and particularly relates to a lithium ion secondary battery using a non-carbonaceous active material-containing negative electrode and a fluorinated ether electrolyte.

### BACKGROUND ART

With rapid expansion in markets of notebook computer, mobile phone, electric car and the like, high energy-density secondary batteries have been desired. Approaches to providing a high energy density secondary battery include, for example, a use of a large-capacity negative electrode material and a use of a nonaqueous electrolyte excellent in stability.

Patent Literature 1 discloses use of an oxide of silicon or silicate as a negative electrode active material of a secondary battery. Patent Literature 2 discloses a secondary-battery negative electrode having an active material layer containing a carbon material particle capable of absorbing and desorbing lithium ions, a metal particle capable of alloying with lithium and an oxide particle capable of absorbing and desorbing lithium ions. Patent Literature 3 discloses a secondary-battery negative electrode material formed by coating the surface of particles having a structure in which silicon fine crystals are dispersed in a silicon compound, with carbon. Patent Literature 4 and Patent Literature 5 disclose a technique for doping a carbon-coated silicon-silicon oxide composite with lithium.

Patent Literature 6 and Patent Literature 7 disclose that a thermosetting resin and a polyimide, which undergo a dehydro-condensation reaction by heating, is used as a negative electrode binder, in the case that a negative electrode active material contains silicon. Patent Literature 8 discloses a nonaqueous electrolyte containing fluorinated ether. Patent Literature 9 discloses that a nonaqueous electrolyte containing fluorinated ether is used as an electrolyte rarely producing carbon dioxide in the case that a negative electrode active material contains silicon.

### CITATION LIST

### Patent Literature

Patent Literature 1: Japanese Patent Laid-Open No. 6-325765
Patent Literature 2: Japanese Patent Laid-Open No. 2003-123740
Patent Literature 3: Japanese Patent Laid-Open No. 2004-47404
Patent Literature 4: Japanese Patent Laid-Open No. 2011-222151
Patent Literature 5: Japanese Patent Laid-Open No. 2011-222153
Patent Literature 6: Japanese Patent Laid-Open No. 2004-22433
Patent Literature 7: Japanese Patent Laid-Open No. 2008-153117
Patent Literature 8: Japanese Patent Laid-Open No. 11-26015
Patent Literature 9: Japanese Patent Laid-Open No. 2011-96637

### SUMMARY OF INVENTION

### Technical Problem

However, the secondary battery, which is described in Patent Literature 1, using silicon oxide as a negative electrode active material has a problem in that if the secondary battery is charged or discharged at 45° C. or more, capacity reduction due to a charge-discharge cycle significantly increases. The secondary-battery negative electrode described in Patent Literature 2 is effective for reducing volume change of the entire negative electrode in absorbing and desorbing lithium, since three types of components have different charge-discharge potentials. In Patent Literature 2, however, there are many points that were not sufficiently studied, such as, the relationship of three components in the coexisting state, or a binder, an electrolyte, an electrode element structure and an outer package, which are indispensable for forming a lithium ion secondary battery. The secondary battery negative electrode material described in Patent Literature 3 is also effective for reducing volume change of the entire negative electrode. However, in Patent Literature 3, there are many points that are not sufficiently studied, such as a binder, an electrolyte, an electrode element structure and an outer package which are indispensable for forming a lithium ion secondary battery. The secondary-battery negative electrode materials described in Patent Literature 4 and Patent Literature 5 also can improve the energy density of a secondary battery. However, there are many points that are not sufficiently studied, such as a binder, an electrolyte, an electrode element structure and an outer package, which are indispensable for forming a lithium ion secondary battery.

In Patent Literature 6 and Patent Literature 7, a negative electrode binder is described. However, studies on the state of a negative electrode active material are insufficient. In addition, there are many points that are not sufficiently studied, such as an electrolyte, an electrode element structure and an outer package, which are indispensable for forming a lithium ion secondary battery. In Patent Literature 8 and Patent Literature 9, an electrolyte containing fluorinated ether is described. However, no studies have been made on a case where a lithium compound is reacted before preparing a secondary battery using a silicon-containing negative electrode active material.

Particularly, while a lithium ion secondary battery using silicon and a silicon oxide as a negative electrode active material has a high capacity, the ratio of capacity which irreversibly change during the initial charging time is high. If charge-discharge is performed under a high-temperature environment, the secondary battery is swollen and a capacity retention rate decreases. Such deterioration of cycle characteristics becomes a problem and development of a technique for solving the problem has been desired.

Then, an embodiment according to the present invention is directed to providing a secondary battery having high energy-density and satisfactory high-temperature cycle characteristics.

### Solution to Problem

An embodiment according to the present invention relates to a lithium ion secondary battery having an electrode element in which a positive electrode and a negative electrode are arranged so as to face each other, an electrolyte and an outer package housing the electrode element and the electrolyte, wherein the negative electrode is formed by using a second negative electrode active material in which lithium is doped into a first negative electrode active material containing a metal (a) capable of forming an alloy with lithium, a metal oxide (b) capable of absorbing and desorbing lithium ions, and a carbon material (c) capable of absorbing and desorbing lithium ions;

and the electrolyte contains a fluorinated ether compound represented by the following formula (1);

Ra—O—Rb (1)

in which Ra and Rb each independently represent alkyl group or fluorine-substituted alkyl group; and at least one of Ra and Rb is fluorine-substituted alkyl group,
and relates to a method for manufacturing the lithium ion secondary battery.

### Advantageous Effects of Invention

According to the embodiment according to the present invention, it is possible to provide a secondary battery having high energy-density and satisfactory high-temperature cycle characteristics.

### BRIEF DESCRIPTION OF DRAWING

FIG. 1 is a schematic sectional view showing a structure of an electrode element used in a laminate type secondary battery.

### DESCRIPTION OF EMBODIMENT

The present embodiment will be more specifically described below.

A secondary battery according to the present embodiment has an electrode element having a positive electrode and a negative electrode arranged to face each other and an electrolyte, housed in an outer package. The secondary battery may be a cylindrical type, a planar winding rectangular type, a laminate rectangular type, a coin type, a planar winding laminate type or a laminate type; the secondary battery is preferably a laminate type. Now, a laminate type secondary battery will be described below.

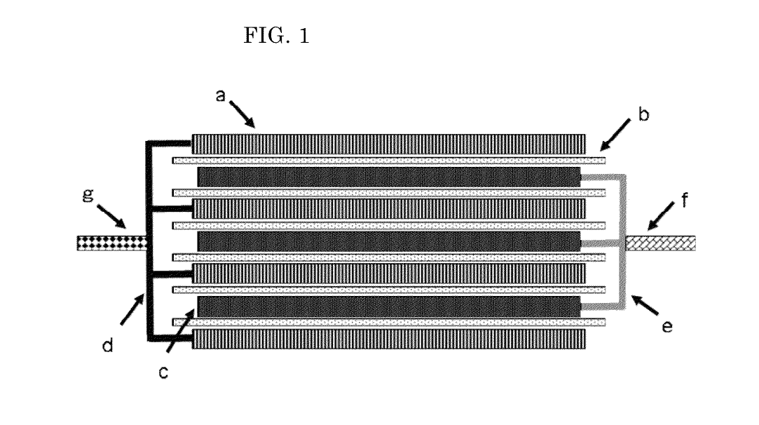

FIG. 1 is a schematic cross-sectional view illustrating the structure of an electrode element of a laminated type secondary battery. In this electrode element, a plurality of positive electrodes c and a plurality of negative electrode a both having a planar structure are alternately stacked with a separator b sandwiched therebetween. Positive electrode collectors e of the respective positive electrodes c are welded to one another in end portions not covered with a positive electrode active material so as to be electrically connected to one another, and a positive electrode terminal f is further welded to the welded portion among them. Negative electrode collectors d of the respective negative electrodes a are welded to one another in end portions not covered with a negative electrode active material so as to be electrically connected to one another, and a negative electrode terminal g is further welded to the welded portion among them.

In the electrode element having such a planar layered structure, no portion has small R (region near a winding core of a concentric circle winding structure or a folding region corresponding to an end of flat-winding structure), and therefore, such an electrode element has an advantage that it is difficult to be harmfully affected by the volume change of the electrode caused through the charge/discharge cycle as compared with an electrode element having a winding structure. In other words, it is effectively used as an electrode element using an active material with which the volume expansion is liable to occur. On the other hand, since an electrode is bent in an electrode element having a winding structure, the structure is easily warped if the volume change is caused. In particular, if a negative electrode active material with large volume change through the charge/discharge cycle, such as a silicon oxide, is used, the capacity is considered to be largely lowered through the charge/discharge cycle in a secondary battery using an electrode element having a winding structure.

In the electrode element having a planar layered structure, however, if a gas is generated between the electrodes, there arises a problem that the generated gas is liable to stay between the electrodes. This is for the following reason: In the electrode element having a winding structure, tension is applied to the electrodes and hence a distance between the electrodes is difficult to increase, but in the electrode element having a layered structure, a distance between the electrodes is easily increased. If an aluminum laminated film is used as the outer package, this problem becomes particularly conspicuous.

As described in Patent Literature 4 and Patent Literature 5, a technique for previously doping a silicon negative electrode active material in a powder state with lithium is effective for improving energy density. However, as a result of studies conducted by the present inventors, it was found that when a negative electrode active material in a powder state is doped with lithium, a problem of deterioration of characteristics of a laminate cell has arisen because the amount of gas generation increases due to the reasons: (1) the number of active sites on the surface of a negative electrode increases due to a reaction product with lithium; (2) reactivity with water within a battery increases; (3) the irreversible capacity of a negative electrode decreases and the charge-discharge range of a positive electrode is widened, with the result that deterioration of the positive electrode proceeds; and (4) when reaction is performed with lithium hydride or lithium aluminum hydride, it is desirable that a treatment is performed at a temperature as low as possible, for reducing cost; however, if the treatment is performed at 700° C. or less, a side reaction of an unreacted lithium compound occurs during initial charging time.

In the present embodiment, the aforementioned problems can be solved and long life driving of the laminate type lithium ion secondary battery using a high-energy negative electrode can be achieved.

### [1] Negative Electrode

In the present embodiment, a negative electrode is prepared using a negative electrode active material doped with lithium. The negative electrode active material contains a metal (a) capable of forming an alloy with lithium, a metal oxide (b) capable of absorbing and desorbing lithium ions and a carbon material (c) capable of absorbing and desorbing lithium ions. In the specification, the negative electrode active material before doped with lithium is hereinafter referred to as a first negative electrode active material; whereas the negative electrode active material doped with lithium is referred to as a second negative electrode active material. Note that, in the specification, the description of “negative electrode active material” alone refers to both first negative electrode active material and second negative electrode active material, unless otherwise explicitly described. The phrase “dope with lithium” means that the first negative electrode active material is brought into contact with lithium to react with each other, and also the description of “dope treatment” or “perform pre-dope treatment with lithium” may be used in the specification.

First, the metal (a), metal oxide (b) and carbon material (c) contained in a negative electrode active material will be described.

As the metal (a), Al, Si, Pb, Sn, In, Bi, Ag, Ba, Ca, Hg, Pd, Pt, Te, Zn, La or alloys of two or more of these can be used. Particularly, as the metal (a), silicon (Si) is preferably included. The content of the metal (a) in the negative-electrode active material is, preferably 5 mass % or more and 95 mass % or less, more preferably 10 mass % or more and 90 mass % or less, and further preferably 20 mass % or more and 50 mass % or less.

As the metal oxide (b), silicon oxide, aluminum oxide, tin oxide, indium oxide, zinc oxide, lithium oxide or composites of two or more of these can be used. Particularly, as the metal oxide (b), silicon oxide is preferably included. This is because silicon oxide is relatively stable and rarely causes a reaction with another compound. Moreover, to the metal oxide (b), one or two or more elements selected from nitrogen, boron and sulfur can be added, for example, in an amount of 0.1 to 5 mass %. This improves the electric conductivity of the metal oxide (b). The content of the metal oxide (b) in the negative-electrode active material, preferably 5 mass % or more and 90 mass % or less, more preferably 40 mass % or more and 80 mass % or less, and further preferably 50 mass % or more and 70 mass % or less.

It is preferable that the metal oxide (b) wholly or partly has an amorphous structure. The metal oxide (b) having an amorphous structure can suppress volume expansion of other negative electrode active material of carbon material (c) and metal (a) and also suppress decomposition of an electrolyte. Although the mechanism of this is unclear, the amorphous structure of the metal oxide (b) may probably have some effect on formation of a film on the interface between the carbon material (c) and an electrolyte. Furthermore, the amorphous structure contains relatively small numbers of factors associated with non-uniformity such as crystal grain boundary and defects. Note that whether whole or part of the metal oxide (b) has an amorphous structure can be checked by X-ray diffraction analysis (general XRD analysis). Specifically, if the metal oxide (b) does not have an amorphous structure, a peak intrinsic to the metal oxide (b) is observed, whereas if the whole or part of the metal oxide (b) has an amorphous structure, a broad peak is observed as the peak intrinsic to the metal oxide (b).

Furthermore, it is preferable that the whole or part of the metal (a) is dispersed in the metal oxide (b). If at least a portion of the metal (a) is dispersed in the metal oxide (b), the volume expansion of the entire negative electrode can be further suppressed and also the decomposition of an electrolyte can be further suppressed. Note that whether the whole or part of the metal (a) is dispersed in the metal oxide (b) can be checked by using transmission electron microscopic observation (general TEM observation) and energy dispersive X-ray spectrometry analysis (general EDX analysis) in combination. More specifically, this can be checked by observing a section of a sample containing the metal (a) particle and measuring the oxygen concentration of the metal (a) particles dispersed in the metal oxide (b) to confirm that the metal constituting the metal (a) particle is not converted into an oxide.

Furthermore, the metal oxide (b) is preferably an oxide of a metal constituting the metal (a).

The ratio of a metal (a) and a metal oxide (b) is not particularly limited. The ratio of the metal (a) relative to the total of the metal (a) and the metal oxide (b) is preferably 5 mass % or more and 90 mass % or less and preferably 30 mass % or more and 60 mass % or less. The ratio of the metal oxide (b) relative to the total of the metal (a) and the metal oxide (b) is preferably 10 mass % or more and 95 mass % or less and preferably 40 mass % or more and 70 mass % or less.

As the carbon material (c), graphite, amorphous carbon, diamond-like carbon, carbon nanotube or a composite of these can be used. Herein, graphite which has high crystallinity, has high electric conductivity, excellent adhesiveness to a positive electrode collector formed of a metal such as copper, and excellent voltage flatness. In contrast, amorphous carbon, which has low crystallinity, is relatively low in volume expansion. Because of this, it is highly effective to reduce volume expansion of the entire negative electrode, and in addition, deterioration due to non-uniformity such as crystal grain boundary and defect rarely occurs. The content of a carbon material (c) in a negative electrode active material is preferably 2 mass % or more and 50 mass % or less, and more preferably, 2 mass % or more and 30 mass % or less in order to ensure low resistance and high output power as a negative electrode.

The ratio of the metal (a), metal oxide (b) and carbon material (c) contained in the negative-electrode active material is not particularly limited. The content of the metal (a) is preferably 5 mass % or more and 90 mass % or less relative to the total of the metal (a), metal oxide (b) and carbon material (c), and preferably 20 mass % or more and 50 mass % or less. The content of the metal oxide (b) is preferably 5 mass % or more and 90 mass % or less relative to the total of the metal (a), metal oxide (b) and carbon material (c), and preferably 40 mass % or more and 70 mass % or less. The content of the carbon material (c) is preferably 2 mass % or more and 50 mass % or less relative to the total of the metal (a), metal oxide (b) and carbon material (c), and more preferably 2 mass % or more and 30 mass % or less.

The forms of the metal (a), metal oxide (b) and carbon material (c) are not particularly limited; however, particulate forms can be used. For example, the average particle size of the metal (a) can be set to be smaller than the average particle size of the metal oxide (b) and the average particle size of the carbon material (c). If so, the metal (a), which is large in volume change during a charge-discharge time, is present in a relatively small particle size; whereas the metal oxide (b) and carbon material (c), which are small in volume change, are present in relatively large particle sizes. Thus, production of dendrite and pulverization of an alloy can be effectively suppressed. Furthermore, during a charge-discharge process, lithium is adsorbed or desorbed sequentially in the order of a large-size particle, a small-size particle and a large-size particle. Also in this respect, occurrence of residual stress and residual strain is suppressed. The average particle size of the metal (a) can be set, for example, at 10 μm or less and preferably 5 μm or less.

A carbon material (c) may be localized near the surface of particles formed of a metal (a) and a metal oxide (b), like coating. Aggregation of carbon can be prevented by the local presence of carbon, which is effective in reducing volume expansion and uniformity of electronic conductivity, in view of an entire electrode.

In the present embodiment, the first negative electrode active material can be prepared, for example, by mixing a metal (a), a metal oxide (b) and a carbon material (c) by a mechanical milling. Furthermore, a first negative electrode active material in which whole or part of the metal oxide (b) has an amorphous structure, whole or part of the metal (a) is dispersed in the metal oxide (b), a carbon material (c) is localized, can be prepared by a method disclosed, for example, in Patent Literature 3. More specifically, a metal oxide (b) is subjected to a CVD process under an atmosphere containing an organic gas such as methane gas to obtain a composite containing the nano-clustered metal (a) in the metal oxide (b) and having a surface coated with a carbon material (c). Furthermore, the first negative-electrode active material can be also prepared by stepwisely mixing a metal (a), a metal oxide (b) and a carbon material (c) by mechanical milling.

In the present embodiment, the first negative electrode active material obtained above is doped with lithium to prepare the second negative electrode active material. The first negative electrode active material to be doped with lithium may be used alone or may be mixed with a negative electrode binder, etc. The form of the first negative electrode active material to be doped with lithium is not particularly limited, for example, may be powder state or slurry. Examples of the first negative electrode active material in a powder state include a powder solely consisting of the first negative electrode active material, and a powder mixture of the first negative electrode active material and a negative electrode binder. Examples of the first negative electrode active material in a slurry state include slurry obtained by mixing the first negative electrode active material and an organic solvent such as n-methylpyrrolidone and slurry obtained by mixing the first negative electrode active material, a negative electrode binder and an organic solvent such as n-methylpyrrolidone. Of these, lithium-pre-dope treatment is preferably preformed to the powder solely consisting of the first negative electrode active material.

In the case that a first negative electrode active material is in a powder state, a method for doping the first negative electrode active material with lithium that can be available may be, for example, a method described in Patent Literature 4 or Patent Literature 5. More specifically, it is preferable that the first negative electrode active material in a powder state and a lithium source are mixed in a predetermined molar ratio and thereafter the mixture is subjected to a heat treatment. The predetermined molar ratio herein refers to the molar ratio of a “metal contained in the first negative electrode active material in a powder state” to “lithium contained in the lithium source”, which is preferably 5:1 to 0.5:1 and further preferably 2:1 to 0.8:1. Note that the “metal contained in the first negative electrode active material” refers to a metal (a) and a metal contained in a metal oxide (b). The heat treatment temperature is not particularly limited; however, the temperature is preferably 100° C. or more and 800° C. or less, more preferably 100° C. or more and 700° C. or less and further preferably 200° C. or more and 700° C. or less. As the lithium source to be mixed with the first negative electrode active material in a powder state, the examples thereof include lithium metal, organic lithium compounds, lithium hydride and lithium aluminum hydride. Among these, lithium hydride and lithium aluminum hydride are more preferable. Furthermore, these lithium sources may be used alone or in combination with two or more.

In a method of doping a first negative electrode active material with lithium if the first negative electrode active material is in a slurry state, for example, the first negative electrode active material can be doped with lithium by mixing slurry containing the first negative electrode active material with a lithium source under an atmosphere of a temperature of 60° C. to 125° C. At this time, the molar ratio of the “metal contained in the first negative electrode active material” and the “lithium contained in the lithium source” in the slurry is preferably 5:1 to 0.5:1 and further preferably 2:1 to 0.8:1. As the lithium source to be mixed with a first negative electrode active material in the form of slurry, the examples thereof include lithium metal, organic lithium compounds, lithium hydride and lithium aluminum hydride. Among these, a lithium metal, lithium hydride and lithium aluminum hydride are more preferable. Furthermore, these lithium sources may be used alone or in combination of two or more.

As the negative electrode binder, polyvinylidene fluoride, vinylidene fluoride-hexafluoropropylene copolymers, vinylidene fluoride-tetrafluoroethylene copolymers, styrene-butadiene copolymer rubbers, polytetrafluoroethylene, polypropylene, polyethylene, polyimides and polyamide-imides are generally used. In the present embodiment, polyimides or polyamide-imides are preferably used. The content of the negative electrode binder to be used in the negative electrode is preferably 5 to 20 mass %, and more preferably 8 to 15 mass % relative to the total amount of the negative-electrode active material and the negative electrode binder in view of the trade-off relationship between “sufficient binding property” and “high energy production”.

As the negative electrode collector, in view of electrochemical stability, aluminum, nickel, copper, silver and an alloy of these are preferable. The shape thereof may be in the form of foil, flat-plate or mesh.

The negative electrode may be prepared by forming a negative-electrode active material layer containing the second negative-electrode active material and a negative electrode binder, on a negative electrode collector. As a method for forming a negative-electrode active material layer, a doctor blade method, a die coater method, a CVD method and a sputtering method may be used. A negative-electrode active material layer is formed in advance, and then, a thin film of aluminum, nickel or an alloy of them is formed by a method such as vapor deposition or sputtering to form a negative electrode collector.

### [2] Positive Electrode

A positive electrode has, for example, a positive electrode active material bound to a positive electrode collector with a positive electrode binder so that the positive electrode collector is covered therewith.

Examples of the positive electrode active material include:

lithium manganates having a laminate structure or a spinel structure such as LiMnO₂ and LiₓMn₂O₄ (0<x<2);

LiCoO₂, LiNiO₂ or those obtained by replacing a part of these transition metals of these with another metal;

lithium transition metal oxides in which a particular transition metal does not exceed a half such as LiNi_{1/3}Co_{1/3}Mn_{1/3}O₂; and

those containing Li in an amount excessively larger than the stoichiometric composition (amount) in these lithium transition metal oxides. Particularly, Li_{α}Ni_{β}Co_{γ}Al_{δ}O₂ (1≦α≦1.2, β+γ+δ=1, β≧0.7, γ≦0.2) or Li_{α}Ni_{β}Co_{γ}Mn_{δ}O₂ (1≦α≦1.2, β+γ+δ=1, β≧0.6, γ≦0.2) is preferable. The positive electrode active materials can be used alone or in combination of two types or more.

As the positive electrode binder, the same compounds as mentioned for the negative electrode binder can be used. Among them, in view of general versatility and low cost, polyvinylidene fluoride is preferable. The amount of positive electrode binder to be used is preferably 2 to 10 parts by mass relative to 100 parts by mass of the positive electrode active material in consideration of the trade-off relationship between “sufficient binding property” and “high energy production”.

As a positive electrode collector, the same material as used in a negative electrode collector can be used.

To a positive electrode active material layer containing a positive electrode active material, a conductive aid may be added in order to reduce impedance. As the conductive aid, carbonaceous fine particles of graphite, carbon black, acetylene black and the like are exemplified.

### [3] Electrolyte

In the present embodiment, an electrolyte contains a fluorinated ether compound represented by the following formula (1):

Ra—O—Rb (1)

in which Ra and Rb each independently represent alkyl group or fluorine-substituted alkyl group; and at least one of Ra and Rb is fluorine-substituted alkyl group.

Examples of the fluorinated ether compound represented by the above formula (1) include fluorinated ether compounds corresponding to linear mono-ether compounds in which part or whole of hydrogen is substituted by fluorine; the linear mono-ether compounds including dimethyl ether, methyl ethyl ether, diethyl ether, methyl propyl ether, ethyl propyl ether, dipropyl ether, methyl butyl ether, ethyl butyl ether, propyl butyl ether, dibutyl ether, methyl pentyl ether, ethyl pentyl ether, propyl pentyl ether, butyl pentyl ether, and dipentyl ether. More specifically, it is preferable to use CF₃CH₂OCF₃, CF₃CH₂OCF₂CF₂H or a fluorinated ether compound represented by the following formula (2):

H—(CX¹X²—CX³X⁴)ₙ—CH₂O—CX⁵X⁶—CX⁷X⁸—H (2)

(in which n is 1, 2, 3 or 4; X¹ to X⁸ are each independently a fluorine atom or a hydrogen atom, if n is 2 or more, existing n numbers of X¹ to X⁴ are independent each other, and at least one of X¹ to X⁴ is a fluorine atom and at least one of X⁵ to X⁸ is a fluorine atom; in addition, in the atomic ratio of fluorine atoms and the hydrogen atoms bound to a compound of formula (2), [(total number of fluorine atoms)/(total number of hydrogen atoms)]≧1 is satisfied);
and more preferable to use a fluorinated ether compound represented by the following formula (3):

H—(CF₂—CF₂)ₙ—CH₂O—CF₂—CF₂—H (3)

where n is 1 or 2.

The electrolyte to be used in the present embodiment preferably contains a fluorinated ether compound represented by formula (1) in an amount of 10 to 60 vol % and more preferably in an amount of 20 to 50 vol % relative to the total volume of the electrolyte. Furthermore, the fluorinated ether compounds represented by formula (1) may be used alone or in combination of two or more.

The electrolyte used in the present embodiment include, in addition to the fluorinated ether compound, a nonaqueous electrolyte stable at operation voltage of the battery. Specific examples of the nonaqueous electrolyte include aprotonic organic solvents such as cyclic carbonates including propylene carbonate (PC), ethylene carbonate (EC), butylene carbonate (BC) and vinylene carbonate (VC); linear carbonates including dimethyl carbonate (DMC), diethyl carbonate (DEC), ethylmethyl carbonate (EMC) and dipropyl carbonate (DPC); propylene carbonate derivatives; and aliphatic carboxylic acid esters including methyl formate, methyl acetate and ethyl propionate. Preferable examples of the nonaqueous electrolyte include cyclic or linear carbonates such as ethylene carbonate (EC), propylene carbonate (PC), butylene carbonate (BC), vinylene carbonate (VC), dimethyl carbonate (DMC), diethyl carbonate (DEC), ethylmethyl carbonate (MEC) and dipropyl carbonate (DPC). Furthermore, as a nonaqueous electrolyte, non-fluorinated linear ether compounds, fluorinated linear ether compounds except the fluorinated linear ether compounds represented by formula (1) and cyclic ether compounds may be included.

Examples of the non-fluorinated linear ether compound include non-fluorinated linear monoether compounds such as dimethyl ether, methyl ethyl ether, diethyl ether, methyl propyl ether, ethyl propyl ether, dipropyl ether, methyl butyl ether, ethyl butyl ether, propyl butyl ether, dibutyl ether, methyl pentyl ether, ethyl pentyl ether, propyl pentyl ether, butyl pentyl ether, and dipentyl ether; and non-fluorinated linear diether compounds such as 1,2-dimethoxyethane (DME), 1,2-diethoxyethane (DEE), ethoxymethoxyethane (EME), 1,2-dipropoxyethane, propoxyethoxyethane, propoxymethoxyethane, 1,2-dibutoxyethane, butoxypropoxyethane, butoxyethoxyethane, butoxymethoxyethane, 1,2-dipentoxyethane, pentoxybutoxyethane, pentoxypropoxyethane, pentoxyethoxyethane, and pentoxymethoxyethane.

Examples of the fluorinated linear ether compound except the fluorinated linear ether compounds represented by formula (1) include fluorinated linear diether compounds corresponding to non-fluorinated linear diether compounds in which part of hydrogen is substituted by fluorine; the non-fluorinated linear diether compounds including 1,2-dimethoxyethane (DME), 1,2-diethoxyethane (DEE), ethoxymethoxyethane (EME), 1,2-dipropoxyethane, propoxyethoxyethane, propoxymethoxyethane, 1,2-dibutoxyethane, butoxypropoxyethane, butoxyethoxyethane, butoxymethoxyethane, 1,2-dipentoxyethane, pentoxybutoxyethane, pentoxypropoxyethane, pentoxyethoxyethane, and pentoxymethoxyethane.

Examples of the cyclic ether compound include non-fluorinated cyclic monoether compounds such as ethylene oxide, propylene oxide, oxetane, tetrahydrofuran, 2-methyl tetrahydrofuran, 3-methyl tetrahydrofuran, tetrahydropyran, 2-methyl tetrahydropyran, 3-methyl tetrahydropyran, and 4-methyl tetrahydropyran; non-fluorinated cyclic diether compounds such as 1,3-dioxolane, 2-methyl-1,3-dioxolane, 4-methyl-1,3-dioxolane, 1,4-dioxane, 2-methyl-1,4-dioxane, 1,3-dioxane, 2-methyl-1,3-dioxane, 4-methyl-1,3-dioxane, 5-methyl-1,3-dioxane, 2,4-dimethyl-1,3-dioxane, and 4-ethyl-1,3-dioxane; and fluorinated cyclic ether compounds corresponding to those in which part of hydrogen of these non-fluorinated cyclic ether compounds is substituted by fluorine.

The nonaqueous electrolytes may be used alone or in combination of two or more.

The electrolyte used in the present embodiment preferably contains a supporting electrolyte in the mixture solution of the fluorinated ether compound and the nonaqueous electrolyte. Specific examples of the supporting electrolyte include lithium salts such as LiPF₆, LiAsF₆, LiAlCl₄, LiClO₄, LiBF₄, LiSbF₆, LiCF₃SO₃, LiC₄F₉SO₃, Li(CF₃SO₂)₂ and LiN(CF₃SO₂)₂. The supporting electrolytes can be used singly or in combination of two types or more.

### [4] Separator

As the separator, a porous film or a nonwoven fabric of polypropylene or polyethylene or the like can be used. Alternatively, a separator obtained by laminating such a material may be used.

### [5] Outer Package

As the outer package, as long as it is stable in an electrolyte and has a sufficient vapor barrier, any material can be appropriately selected. For example, in the case of a laminate type secondary battery, a laminate film of polypropylene or polyethylene coated with aluminum or silica, or the like can be used as the outer package. Particularly, in view of suppression of volume expansion, an aluminum laminate film is preferably used.

In the case of a secondary battery using a laminate film as an outer package, if gas is generated, deformation of an electrode element becomes significantly large compared to a secondary battery using a metal can as an outer package. This is because the laminate film is easily deformed by the inner pressure of a secondary battery compared with a metal can. Furthermore, in sealing a secondary battery using a laminate film as an outer package, usually, the inner pressure of the battery is lower than the atmospheric pressure, and thus, no extra space is present in the interior portion. Therefore, if gas is generated, it may directly lead to the change of volume of the battery and the deformation of the electrode element.

The secondary battery according to the present embodiment can overcome the aforementioned problems. By virtue of this, a laminate type lithium ion secondary battery having an excellent degree of freedom in cell capacity design can be provided at low cost by changing the number of laminate layers.

### EXAMPLES

The present embodiment will be more specifically described by way of Examples.

### Example 1

Tin having an average particle size of 5 μm and serving as a metal (a), a silicon oxide having an average particle size of 10 μm and serving as a metal oxide (b) and graphite having an average particle size of 20 μm and serving as a carbon material (c) were weighed in a mass ratio of 30:60:10 and mixed to obtain a negative electrode active material. The negative electrode active material and a polyamide-imide (PAI, trade name: VYLOMAX (registered trade mark), manufactured by Toyobo Co., Ltd.) serving as a negative electrode binder were weighed in a mass ratio of 85:15 and mixed with n-methylpyrrolidone to prepare negative electrode slurry.

Subsequently, to the negative electrode slurry, metal lithium powder was added at a low dew-point atmosphere at 80° C. so as to obtain a weight ratio of the negative electrode active material:metal lithium powder=10:1 (molar ratio of the metal contained in the negative electrode active material:lithium=about 0.8:1) and stirred to perform lithium doping.

Thereafter, the negative electrode slurry was applied to copper foil having a thickness of 15 μm, dried and subjected to a heat treatment under a nitrogen atmosphere at 300° C. to prepare a negative electrode.

Lithium nickelate (LiNi_{0.80}Co_{0.15}Al_{0.15}O₂) serving as a positive electrode active material, carbon black serving as a conductive aid and polyvinylidene fluoride serving as a positive electrode binder were weighed so as to satisfy a mass ratio of 90:5:5, and mixed with n-methylpyrrolidone to prepare positive electrode slurry. The positive electrode slurry was applied to aluminum foil of 20 μm in thickness and dried, and further pressed to prepare a positive electrode.

Three layers of the positive electrode and four layers of the negative electrode thus obtained were alternately stacked, with polypropylene porous films used as separator sandwiched therebetween. The end portions of the positive electrode collectors not covered with the positive electrode active material and the end portions of the negative electrode collectors not covered with the negative electrode active material were separately welded, and a positive electrode terminal made of aluminum and a negative electrode terminal made of nickel were attached by welding to the respective welded portions to obtain an electrode element having a planar laminate structure.

Linear/cyclic carbonate based electrolyte (EC/PC/DMC/EMC/DEC (EC/PC/DMC/EMC/DEC=2/2/2/2/2 in volume ratio)) and fluorinated ether CF₃CH₂OCF₃ were mixed in a proportion of 50:50 (volume ratio), and supporting electrolyte of LiPF₆ was dissolved in a concentration of 1 mole/L to obtain an electrolyte.

The above electrode element was wrapped with aluminum laminate film serving as an outer package and the electrolyte was injected within the outer package, which was then sealed while the pressure was reduced to 0.1 atm to prepare a secondary battery.

<Charge-Discharge Evaluation>

The obtained secondary battery was charged and discharged under an environment of 20° C. at a current of 0.1 C, with an upper limit voltage of 4.2 V and a lower limit voltage of 2.7 V. At this time, the initial charge-discharge efficiency and the amount of gas generation were determined. The amount of gas generation was determined by measuring the volume before the initial charge-discharge by the Archimedes method and indicated by a ratio of the volume after the initial charge-discharge of {(after initial charge-discharge/before initial charge-discharge)×100(%)}. The results are shown in Table 1.

### Example 2

The same procedure as in Example 1 was repeated except that CF₃CH₂OCF₂CF₂H was used as a fluorinated ether. The results are shown in Table 1.

### Example 3

The same manner as in Example 1 was repeated except that HCF₂CF₂CH₂OCF₂CF₂H was used as a fluorinated ether. The results are shown in Table 1.

### Comparative Example 1

The same procedure as in Example 1 was repeated except that an electrolyte, which was prepared by dissolving LiPF₆ serving as a supporting electrolyte in a concentration of 1 mole/L in a linear/cyclic carbonate electrolyte (EC/PC/DMC/EMC/DEC), was used in place of the fluorinated ether. The results are shown in Table 1.

### Comparative Example 2

The same procedure as in Example 1 was repeated except that slurry was not doped with lithium. The results are shown in Table 1.

### Example 4

As a method of lithium doping, doping was not performed in the stage of slurry but was performed in the stage of powder. More specifically, when a negative electrode active material was in a powder state, the negative electrode active material and metal lithium powder were mixed in a weight ratio of negative electrode active material:metal lithium powder=10:1 (the molar ratio of metal contained in the negative electrode active material:lithium=about 0.8:1) and reacted in an explosion-proof constant-temperature vessel at 100° C. for 8 hours. The negative electrode active material doped with lithium in this manner and polyamide-imide (PAI, trade name: VYLOMAX (registered trade mark), manufactured by Toyobo Co., Ltd.) serving as a negative electrode binder were weighed so as to satisfy a mass ratio of 85:15 and mixed with n-methylpyrrolidone to obtain negative electrode slurry. Thereafter, the negative electrode slurry was applied to copper foil having a thickness of 15 μm, dried and subjected to a heat treatment under a nitrogen atmosphere at 300° C. to prepare a negative electrode. The same procedure as in Example 3 was repeated except the preparation of the negative electrode. The results are shown in Table 1.

### Example 5

As a method of lithium doping, doping was not performed in the stage of slurry but was performed in the stage of powder. More specifically, when a negative electrode active material was in a powder-state, the negative electrode active material and metal lithium powder were mixed in a weight ratio of negative electrode active material:lithium hydride=10:1 (the molar ratio of metal contained in the negative electrode active material:lithium=about 0.9:1) and heated up to 600° C. at a rate of 5 minutes per minute and reacted for one hour. The negative electrode active material doped with lithium in this manner and polyamide-imide (PAL trade name: VYLOMAX (registered trade mark), manufactured by Toyobo Co., Ltd.) serving as a negative electrode binder were weighed so as to satisfy a mass ratio of 85:15 and mixed with n-methylpyrrolidone to obtain negative electrode slurry. Thereafter, the negative electrode slurry was applied to copper foil having a thickness of 15 μm, dried and subjected to a heat treatment under a nitrogen atmosphere at 300° C. to prepare a negative electrode. The same procedure as in Example 3 was repeated except the preparation of the negative electrode. The results are shown in Table 1.

### Example 6

As a method of lithium doping, doping was not performed in the stage of slurry but was performed in the stage of powder. More specifically, when a negative electrode active material was in a powder-state, the negative electrode active material and metal lithium powder were mixed in a weight ratio of negative electrode active material:lithium aluminum hydride=10:1 (the molar ratio of metal contained in the negative electrode active material:lithium=about 3.9:1) and heated up to 600° C. at a rate of 5 minutes per minute and reacted for one hour. The negative electrode active material doped with lithium in this manner and polyamide-imide (PAI, trade name: VYLOMAX (registered trade mark), manufactured by Toyobo Co., Ltd.) serving as a negative electrode binder were weighed so as to satisfy a mass ratio of 85:15 and mixed with n-methylpyrrolidone to obtain negative electrode slurry. Thereafter, the negative electrode slurry was applied to copper foil having a thickness of 15 μm, dried and subjected to a heat treatment under a nitrogen atmosphere at 300° C. to prepare a negative electrode. The same procedure as in Example 3 was repeated except the preparation of the negative electrode. The results are shown in Table 1.

### Example 7

Tin having an average particle size of 5 μm and serving as a metal (a), a silicon oxide having an average particle size of 10 μm and serving as a metal oxide (b); graphite having an average particle size of 20 μm and serving as a carbon material (c) were weighed in a mass ratio of 30:60:10 and subjected to mechanical milling under an argon atmosphere. As a result, the metal (a) was dispersed in the metal oxide (b) and the metal oxide (b) was partly changed into an amorphous state. The negative electrode active material and lithium hydride were mixed so as to satisfy a weight ratio of the negative electrode active material:lithium hydride=10:1 (molar ratio of the metal contained in the negative electrode active material:lithium=about 1.5:1), and heated up to 600° C. at a rate of 5 minutes per minute and reacted for one hour. The negative electrode active material thus prepared and doped with lithium and a polyamide-imide (PAL trade name: VYLOMAX (registered trade mark), manufactured by Toyobo Co., Ltd.) serving as a negative electrode binder, were weighed in a mass ratio of 85:15 and mixed with n-methylpyrrolidone to obtain negative electrode slurry. Thereafter, the negative electrode slurry was applied to copper foil having a thickness of 15 μm, dried and subjected to a heat treatment under a nitrogen atmosphere at 300° C. to prepare a negative electrode. The same procedure as in Example 3 was repeated except the preparation of the negative electrode. The results are shown in Table 1.

### Example 8

Tin having an average particle size of 5 μm and serving as a metal (a) and a silicon oxide having an average particle size of 10 μm and serving as a metal oxide (b) were weighed in a mass ratio of 30:60 and subjected to mechanical milling under an argon atmosphere. As a result, the metal (a) was dispersed in the metal oxide (b) and the metal oxide (b) was partly changed into an amorphous state. To the obtained mixture, CVD treatment was applied under an atmosphere containing methane gas at 900° C. for 6 hours to obtain a negative electrode active material having carbon localized near the surface of the negative electrode active material. The negative electrode active material and lithium hydride were mixed in a weight ratio of negative electrode active material:lithium hydride=10:1 (molar ratio of the metal contained in the negative electrode active material:lithium=about 1.5:1), and heated up to 600° C. at a rate of 5 minutes per minute and reacted for one hour. The negative electrode active material thus prepared and doped with lithium and a polyamide-imide (PAT, trade name: VYLOMAX (registered trade mark), manufactured by Toyobo Co., Ltd.) serving as a negative electrode binder were weighed in a mass ratio of 85:15 and mixed with n-methylpyrrolidone to obtain negative electrode slurry. Thereafter, the negative electrode slurry was applied to copper foil having a thickness of 15 μm, dried and subjected to a heat treatment under a nitrogen atmosphere at 300° C. to prepare a negative electrode. The same procedure as in Example 3 was repeated except the preparation of the negative electrode. The results are shown in Table 1.

### Example 9

A silicon-silicon oxide (represented by a general formula of SiO) powder mixture (a mixture of silicon oxide and silicon) was subjected to CVD treatment under an atmosphere containing methane gas at 1150° C. for 6 hours, thereby obtained was a negative electrode active material in which silicon in the silicon oxide was dispersed in the oxide matrix which was in an amorphous state and having carbon particles localized near the surface of the silicon-silicon oxide powder mixture. The mass ratio of silicon/silicon oxide/carbon was controlled to be about 32/63/5.

To the obtained negative electrode active material, lithium hydride was added in a weight ratio of the negative electrode active material:lithium hydride=10:1 (molar ratio of the metal contained in the negative electrode active material:lithium=about 1.6:1), and the mixture was heated up to 600° C. at a rate of 5 minutes per minute and the treatment is performed for one hour. The negative electrode active material thus prepared and doped with lithium, and a polyamide-imide (PAI, trade name: VYLOMAX (registered trade mark), manufactured by Toyobo Co., Ltd.) serving as a negative electrode binder were weighed in a mass ratio of 85:15 and mixed with n-methylpyrrolidone to obtain negative electrode slurry. Thereafter, the negative electrode slurry was applied to copper foil having a thickness of 15 μm, dried and subjected to a heat treatment under a nitrogen atmosphere at 300° C. to prepare a negative electrode. The same procedure as in Example 3 was repeated except the preparation of the negative electrode. The results are shown in Table 1.

### Example 10

The same procedure as in Example 9 was repeated except that a polyimide (trade name: U-Varnish A manufactured by Ube Industries, Ltd.) was used. The results are shown in Table 1.

### Example 11

The same procedure as in Example 9 was repeated except that a mixture of a polyamide-imide (PAI, trade name: VYLOMAX (registered trade mark), manufactured by Toyobo Co., Ltd.) and a polyimide (trade name: U-Varnish A manufactured by Ube Industries, Ltd.) in a weight ratio of 1:1 was used as a negative electrode binder. The results are shown in Table 1.

TABLE 1

| | | | | | Li dope | | | | |
|---|---|---|---|---|---|---|---|---|---|
| | | | | | State of negative | | | | Amount |
| | Negative | | | | electrode active | | | | of gas |
| | electrode | State of | | | material & | | Negative | Effi- | gen- |
| | active | negative | State of | Fluorinated ether | Heating | | electrode | ciency*³ | eration |
| | material | electrode | carbon | compound in electrolyte | temperature | Li source | binder | (%) | (%) |
| Ex. 1*⁴ | Sn—SiO—C | Crystalline | Not | CF₃CH₂OCF₃ | Slurry 80° C. | Metal Li | PAI^{*1} | 80 | 110 |
| | | | localized | | | powder | | | |
| Ex. 2 | Sn—SiO—C | Crystalline | Not | CF₃CHOCF₂CF₂H | Slurry 80° C. | Metal Li | PAI | 80 | 109 |
| | | | localized | | | powder | | | |
| Ex. 3 | Sn—SiO—C | Crystalline | Not | HCF₂CF₂CH₂OCF₂CF₂H | Slurry 80° C. | Metal Li | PAI | 80 | 108 |
| | | | localized | | | powder | | | |
| Comp. Ex. | Sn—SiO—C | Crystalline | Not | None | Slurry 80° C. | Metal Li | PAI | 70 | 250 |
| 1*⁵ | | | localized | | | powder | | | |
| Comp. Ex. | Sn—SiO—C | Crystalline | Not | CF₃CH₂OCF₃ | None | None | PAI | 50 | 110 |
| 2 | | | localized | | | | | | |
| Ex. 4 | Sn—SiO—C | Crystalline | Not | HCF₂CF₂CH₂OCF₂CF₂H | Powder 100° C. | Metal Li | PAI | 80 | 108 |
| | | | localized | | | powder | | | |
| Ex. 5 | Sn—SiO—C | Crystalline | Not | HCF₂CF₂CH₂OCF₂CF₂H | Powder 600° C. | LiH | PAI | 80 | 105 |
| | | | localized | | | | | | |
| Ex. 6 | Sn—SiO—C | Crystalline | Not | HCF₂CF₂CH₂OCF₂CF₂H | Powder 600° C. | LiAlH | PAI | 80 | 105 |
| | | | localized | | | | | | |
| Ex. 7 | Sn—SiO—C | Dispersed | Not | HCF₂CF₂CH₂OCF₂CF₂H | Powder 600° C. | LiH | PAI | 81 | 105 |
| | | Amorphous | localized | | | | | | |
| Ex. 8 | Sn—SiO—C | Dispersed | Localized | HCF₂CF₂CH₂OCF₂CF₂H | Powder 600° C. | LiH | PAI | 82 | 105 |
| | | Amorphous | | | | | | | |
| Ex. 9 | Sn—SiO—C | Dispersed | Localized | HCF₂CF₂CH₂OCF₂CF₂H | Powder 600° C. | LiH | PAI | 85 | 105 |
| | | Amorphous | | | | | | | |
| Ex. 10 | Sn—SiO—C | Dispersed | Localized | HCF₂CF₂CH₂OCF₂CF₂H | Powder 600° C. | LiH | PI*² | 85 | 105 |
| | | Amorphous | | | | | | | |
| Ex. 11 | Sn—SiO—C | Dispersed | Localized | HCF₂CF₂CH₂OCF₂CF₂H | Powder 600° C. | LiH | PAI | 85 | 105 |
| | | Amorphous | | | | | & PI | | |

*¹⁾PAI: Polyamide-imido
*²⁾PI: Polyimide
*³⁾Efficiency: Initial charge-discharge efficiency
*⁴⁾Ex.: Example
*⁵⁾Comp.Ex.: Comparative Example

In the case where the fluorinated ether compound was not added to an electrolyte, the amount of gas generation after the initial charge-discharge reached 2.5 times (Comparative Example 1). In contrast, in the case where the fluorinated ether compound was added to the electrolyte, the amount of gas generation was extremely low (Examples 1 to 11). Furthermore, in the case where lithium doping was not performed (Comparative Example 2), the charge-discharge efficiency was not sufficiently high compared to the case where lithium doping was performed (Examples 1 to 11). As a lithium source for supplying a lithium dopant, lithium hydride and lithium aluminum hydride were appropriate (Examples 5 and 6). Furthermore, charge-discharge efficiency was improved in the case of the negative electrode where a metal (a) is dispersed in the metal oxide (b), which was in an amorphous state (Example 7). This is conceivably because mitigation of volume expansion/contraction is satisfactory and adhesion to an electrode is improved to ensure a sufficient path for electrons and lithium ions. Furthermore, in the case where carbon (c) was localized in the negative electrode active material, the charge-discharge efficiency was improved (Example 8). The reason is conceivably that since carbon (c) has relatively high electronic conductivity, the resistance is lowered, with the result that local occurrence of overvoltage is reduced to allow smooth movement of electrons and lithium ions. Furthermore, in the case where silicon was used as the metal (a), charge-discharge efficiency was improved (Example 9). As a reason, it is considered that the interface between silicon and a silicon oxide is possibly low in interface resistance compared to the interface between another metal and a silicon oxide, and that production of lithium silicate, which is likely to serve as a path for lithium ions, increases. Furthermore, the same performance was obtained if the polyimide and the mixture of the polyamide-imide and the polyimide were used as the negative electrode binder (Examples 10, 11).

### INDUSTRIAL APPLICABILITY

The present embodiment can be used in various industrial fields requiring power supply and the industrial fields of transporting, storing and supplying electric energy. Specifically, the present embodiment can be used as a power supply for mobile equipment such as mobile telephones and note PCs; a power supply for transfer and transportation medium for electric trains, satellites and submarines including electric vehicles such as electric cars, hybrid cars, electric motorcycles and electric assist bicycles; backup power supply such as UPS; and storage equipment for storing electric power obtained by photovoltaic power generation and wind-generated electricity.

### REFERENCE SIGNS LIST

a Negative electrode
b Separator
c Positive electrode
d Negative electrode collector
e Positive electrode collector
f Positive electrode terminal
g Negative electrode terminal

1. A lithium ion secondary battery having an electrode element in which a positive electrode and a negative electrode are arranged so as to face each other, an electrolyte and an outer package housing the electrode element and the electrolyte, wherein
the negative electrode is formed by using a second negative electrode active material in which lithium is doped into a first negative electrode active material containing a metal (a) capable of forming an alloy with lithium, a metal oxide (b) capable of absorbing and desorbing lithium ions, and a carbon material (c) capable of absorbing and desorbing lithium ions;
and the electrolyte contains a fluorinated ether compound represented by the following formula (1):
Ra—O—Rb (1),
in which Ra and Rb each independently represent alkyl group or fluorine-substituted alkyl group; and at least one of Ra and Rb is fluorine-substituted alkyl group.

2. The lithium ion secondary battery according to claim 1, wherein the fluorinated ether compound is represented by the following formula (2):
H—(CX¹X²—CX³X⁴)ₙ—CH₂O—CX⁵X⁶—CX⁷X⁸—H (2)
in which, n is 1, 2, 3 or 4; X¹ to X⁸ are each independently a fluorine atom or a hydrogen atom, if n is 2 or more, existing n numbers of X¹ to X⁴ are independent each other, and at least one of X¹ to X⁴ is a fluorine atom and at least one of X⁵ to X⁸ is a fluorine atom; in addition, in the atomic ratio of fluorine atoms and the hydrogen atoms bound to the compound of formula (2), [(total number of fluorine atoms)/(total number of hydrogen atoms)]≧1 is satisfied.

3. The secondary battery according to claim 1, wherein the second negative electrode active material is obtained by reacting a lithium compound with a first negative electrode active material in a slurry-state.

4. The lithium ion secondary battery according to claim 1, wherein the second negative electrode active material is prepared by reacting a lithium compound with a first negative electrode active material in a powder state.

5. The lithium ion secondary battery according to claim 3, wherein the lithium compound is at least one selected from metal lithium, lithium hydride and lithium aluminum hydride.

6. The lithium ion secondary battery according to claim 1, wherein the second negative electrode active material is prepared by mixing the first negative electrode active material in a powder state and the lithium hydride and/or the lithium aluminum hydride and then performing a heat treatment at a temperature of 100° C. or more and 700° C. or less.

7. The lithium ion secondary battery according to claim 1, wherein whole or part of the metal (a) is dispersed in the metal oxide (b) and whole or part of the metal oxide (b) has an amorphous structure.

8. The lithium ion secondary battery according to claim 1, wherein whole or part of the carbon material (c) is localized near a surface of a particle in which the metal (a) is dispersed in the metal oxide (b) having the amorphous structure.

9. The lithium ion secondary battery according to claim 1, wherein the metal (a) is silicon, the oxide (b) is silicon oxide and/or a silicate compound.

10. The lithium ion secondary battery according to claim 1, wherein
the negative electrode further comprises a negative electrode binder, and
the negative electrode binder comprises at least one selected from polyimides, polyamide-imides or mixtures of these.

11. The lithium ion secondary battery according to claim 1, wherein the electrode element has a planar laminate structure.

12. The lithium ion secondary battery according to claim 1, wherein the outer package is formed of an aluminum laminate film.

13. A method for manufacturing a lithium ion secondary battery having an electrode element in which a positive electrode and a negative electrode are arranged so as to face each other, an electrolyte and an outer package housing the electrode element and the electrolyte, the method comprising the steps of:
preparing a first negative electrode active material containing a metal (a) capable of forming an alloy with lithium, a metal oxide (b) capable of absorbing and desorbing lithium ions, and a carbon material (c) capable of absorbing and desorbing lithium ions;
preparing a second negative electrode active material by doping the first negative electrode active material with lithium;
preparing the negative electrode using the second negative electrode active material;
preparing the electrode element by arranging the positive electrode and the negative electrode so as to face each other; and
enclosing, in the outer package, the electrode element and the electrolyte containing a fluorinated ether compound represented by the following formula (1):
Ra—O—Rb (1)
wherein Ra and Rb each independently represent alkyl group or fluorine-substituted alkyl group; and at least one of Ra and Rb is fluorine-substituted alkyl group.
